(19) United States
(12) Patent Application Publication
(10) Pub. No.: US 2024/0380545 A1
(43) Pub. Date: Nov. 14, 2024

(54) METHOD FOR REPORTING UE RX-TX TIME DIFFERENCE AND GNB RX-TX TIME DIFFERENCE FOR NON-TERRESTRIAL NETWORKS

(71) Applicant: Samsung Electronics Co., Ltd., Gyeonggi-do (KR)

(72) Inventors: Seyed Mohsen HOSSEINIAN, San Diego, CA (US); Philippe Jean Marc Michel SARTORI, Naperville, IL (US); Yuhan ZHOU, San Diego, CA (US)

(21) Appl. No.: 18/661,417

(22) Filed: May 10, 2024

Related U.S. Application Data
(60) Provisional application No. 63/466,086, filed on May 12, 2023.

(51) Int. Cl. H04L 5/00; H04W 4/90; H04W 12/80; H04W 56/00; H04W 64/00; H04W 84/06

(52) U.S. Cl. CPC H04L 5/0051; H04W 4/90; H04W 12/80; H04W 56/0045; H04W 64/00; H04W 84/06

(57) ABSTRACT

A method of reporting a user equipment (UE) time difference in a non-terrestrial network (NTN) is provided, the method includes receiving, from a base station, a positioning reference signal (PRS) in downlink (DL); determining a timestamp or subframe indices of the PRS in DL and a timestamp or subframe indices of the UE uplink (UL) PRS's closest subframe; determining, based on the timestamps or subframe indices, the UE time difference from the reception of the PRS to a transmission of a sounding reference signal (SRS); and reporting, to a location management function (LMF), the SRS based on the UE time difference.

### PRIORITY

This application is based on and claims priority under 35 U.S.C. § 119 (e) to U.S. Provisional Patent Application Ser. Nos. 63/466,086, filed on May 12, 2023, the entire content of which is incorporated herein by reference.

### FIELD

The present disclosure is generally related to improving wireless communication for non-terrestrial networks (NTNs).

### SUMMARY

In the realm of the 3rd Generation Partnership Project (3GPP) Release 18 (Rel-18) for NTN, a predefined level of precision for determining a user equipment (UE) location is necessary to use certain services, including public warning systems (PWS), lawful interception (LI) systems, emergency services (EMS), and charging and tariff notifications. Depending on global navigation satellite systems (GNSS) for pinpointing location presents challenges due to signal weakness in certain positions or the possibility of data tampering. This underscores the necessity for a UE location verification method by the network that does not necessarily rely on GNSS data.

One UE location verification method is a multi-round trip time (multi-RTT) method for terrestrial networks, which utilizes the exchange of positioning reference signals (PRS) and sounding reference signals (SRS) between the gNodeB (gNB) and UE to estimate locations. However, this method may have limitations in NTN scenarios, especially with low earth orbit (LEO) satellites, where the velocity of the satellite significantly impacts the timing of downlink (DL) and uplink (UL) subframes.

To overcome these issues, the present disclosure provides systems and methods for refining UE receive-transmit (Rx-Tx) and gNB Rx-Tx time differences for a multi-RTT method applicable in NTN. An approach is introduced for calculating the time difference between the transmission of PRS from gNB and the reception of SRS by gNB. This involves the use of time stamps (subframe indices) of received PRS at DL and its closest subframe in UL, and the time stamp of the transmit SRS at UL as reported by the UE. Additionally, solutions disclosed herein may incorporate using the aggregate value of a plurality of timing advance (TA) adjustments reported by the UE, which offers a more precise measurement of timing discrepancies influenced by satellite movement. Moreover, the gNB may report its Rx-Tx time difference as defined in 3GPP technical specification (TS) 38.215 Release 17 (Rel-17), further enhancing location accuracy.

Accordingly, embodiments of the present disclosure significantly improve the reliability of UE location verification in NTN environments, addressing the challenges posed by such settings, including the mobility of satellites. The present disclosure offers a robust framework for UE location verification that surpasses previous methods by providing enhanced accuracy for critical services without reliance on GNSS data. Moreover, UE location verification can be achieved using one satellite, and not relying on multiple transmission and reception points (TRPs) on the network.

According to an embodiment, a method of reporting a UE time difference in an NTN includes receiving, from a base station, a PRS in DL; determining a timestamp or subframe indices of the PRS in DL and a timestamp or subframe indices of the UE UL PRS's closest subframe; determining, based on the timestamps or subframe indices, the UE time difference from the reception of the PRS to a transmission of an SRS; and reporting, to a location management function (LMF), the SRS based on the UE time difference.

According to an embodiment, a method of reporting a base station time difference in an NTN includes transmitting, to a UE, a PRS in DL; receiving a timestamp or subframe indices of the PRS in DL and a timestamp or subframe indices of the UE UL PRS's closest subframe; determining, based on the timestamps or subframe indices, the base station time difference from the transmission of the PRS and a reception of an SRS; and reporting, to an LMF, the SRS based on the base station time difference

According to an embodiment, a non-transitory computer readable storage medium having instructions stored thereon is provided. The instructions, when executed by a processor, cause the processor to receive, from a base station, a PRS in DL; determine a timestamp or subframe indices of the PRS in DL and a timestamp or subframe indices of the UE UL PRS's closest subframe; determine, based on the timestamps or subframe indices, a UE time difference from the reception of the PRS to a transmission of an SRS; and reporting, to an LMF, the SRS based on the UE time difference.

### BRIEF DESCRIPTION OF THE DRA WINGS

The above and other aspects, features, and advantages of certain embodiments of the present disclosure will be more apparent from the following detailed description, taken in conjunction with the accompanying drawings, in which:

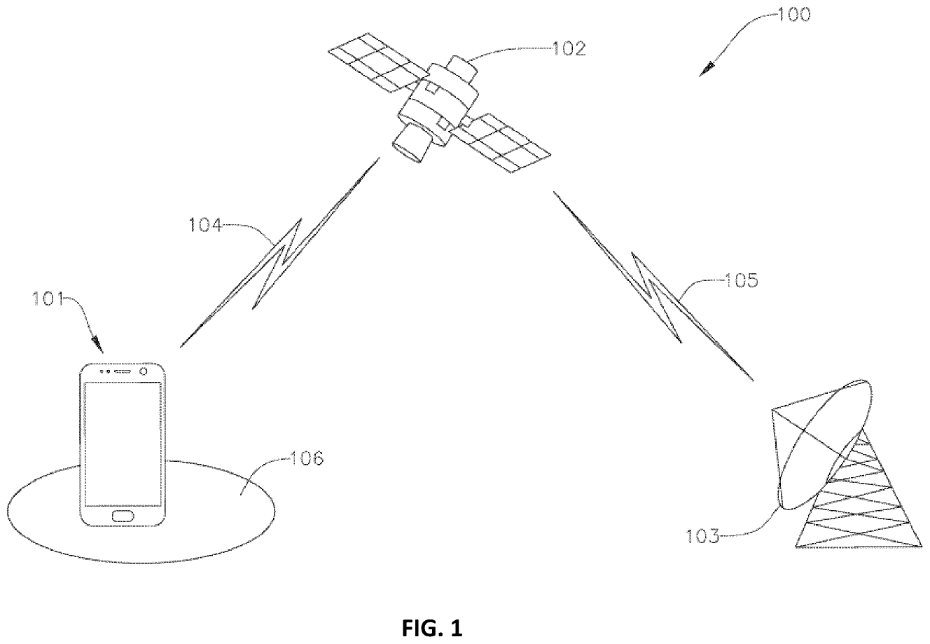

FIG. 1 is a diagram illustrating an NTN network environment, according to an embodiment;

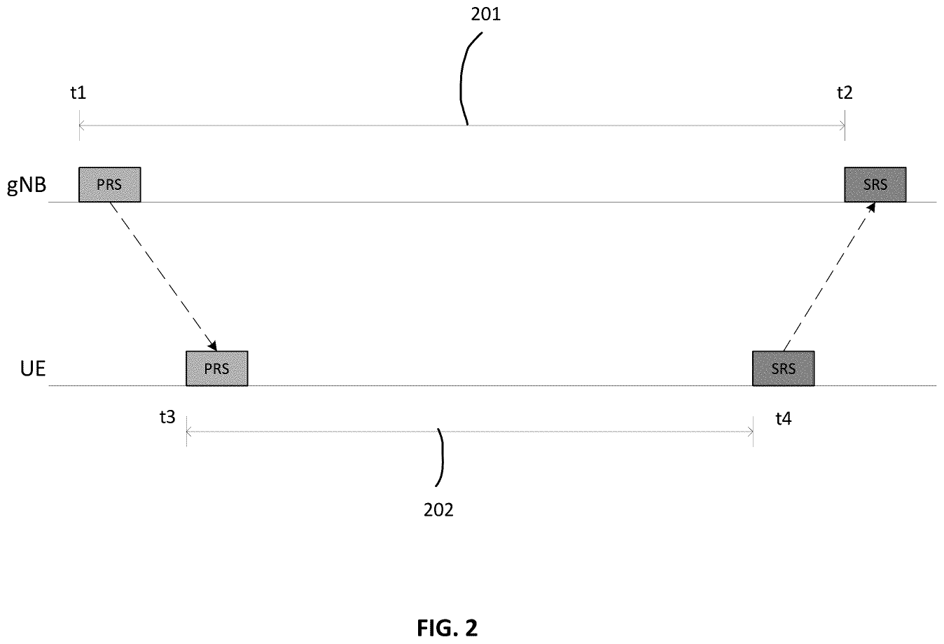

FIG. 2 illustrates a network signaling operation for performing round trip time (RTT) measurement, according to an embodiment;

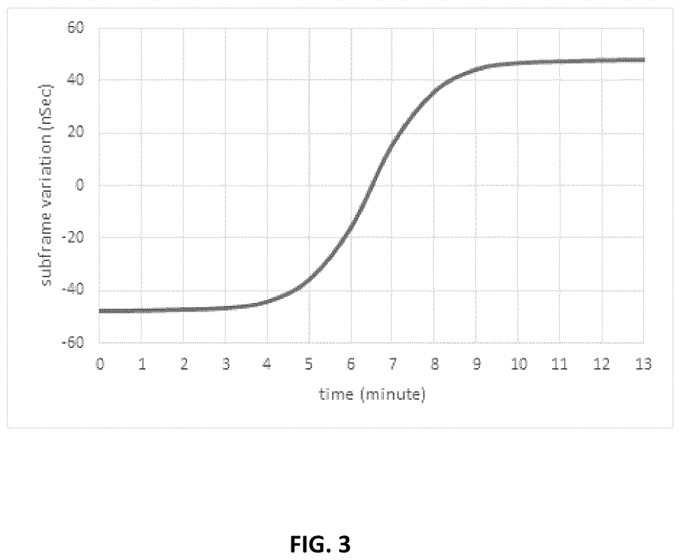

FIG. 3 is a chart depicting DL subframe variation over time, according to an embodiment;

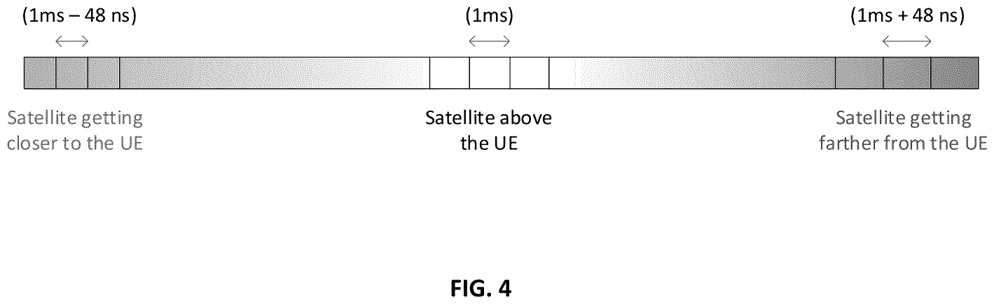

FIG. 4 illustrates the DL subframe length as observed by the UE when a satellite in an LEO-600 scenario passes overhead, according to an embodiment;

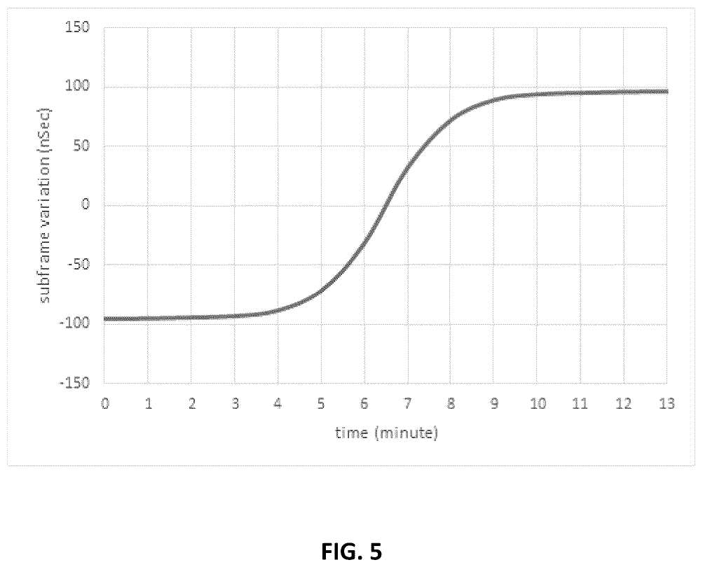

FIG. 5 is a chart depicting UL subframe variation over time, according to an embodiment;

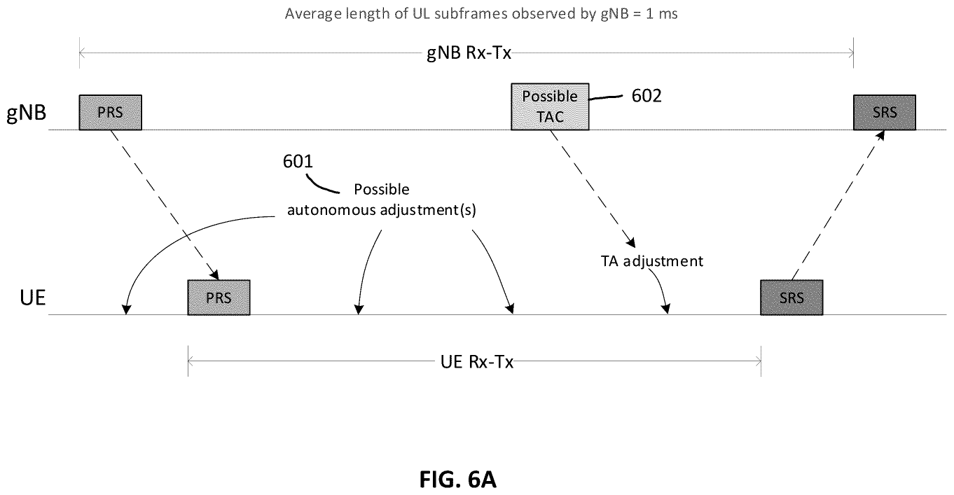

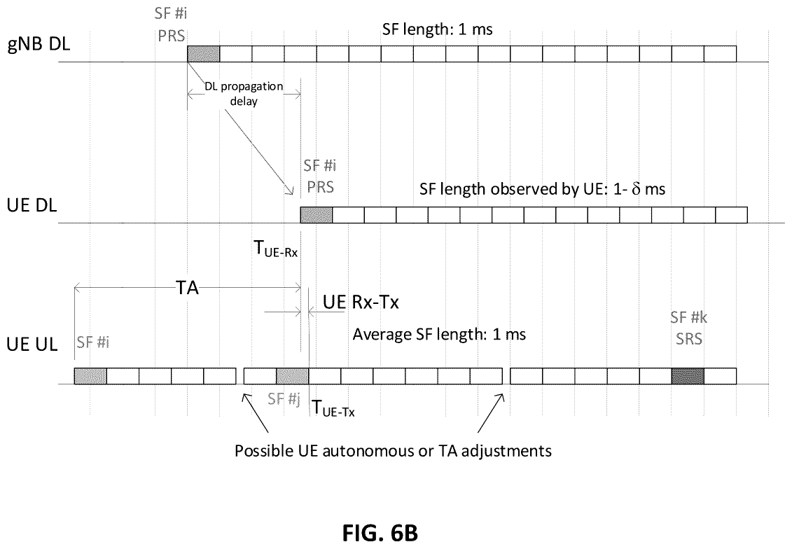

FIG. 6A illustrates a network signaling operation for performing timing adjustments, according to an embodiment;

FIG. 6B illustrates a network signaling operation for performing timing adjustments, according to an embodiment;

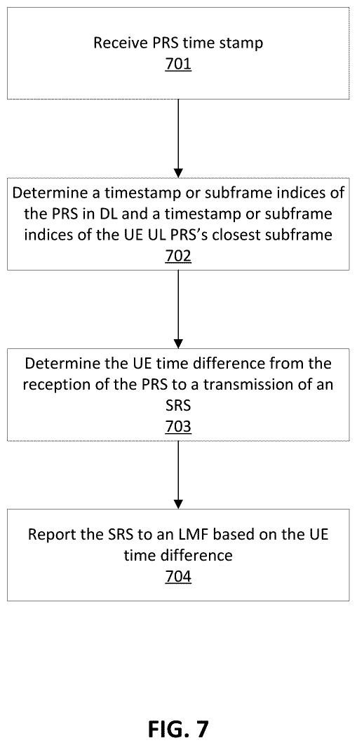

FIG. 7 is a flowchart illustrating a method for verifying a UE location with an LMF in an NTN environment, according to an embodiment;

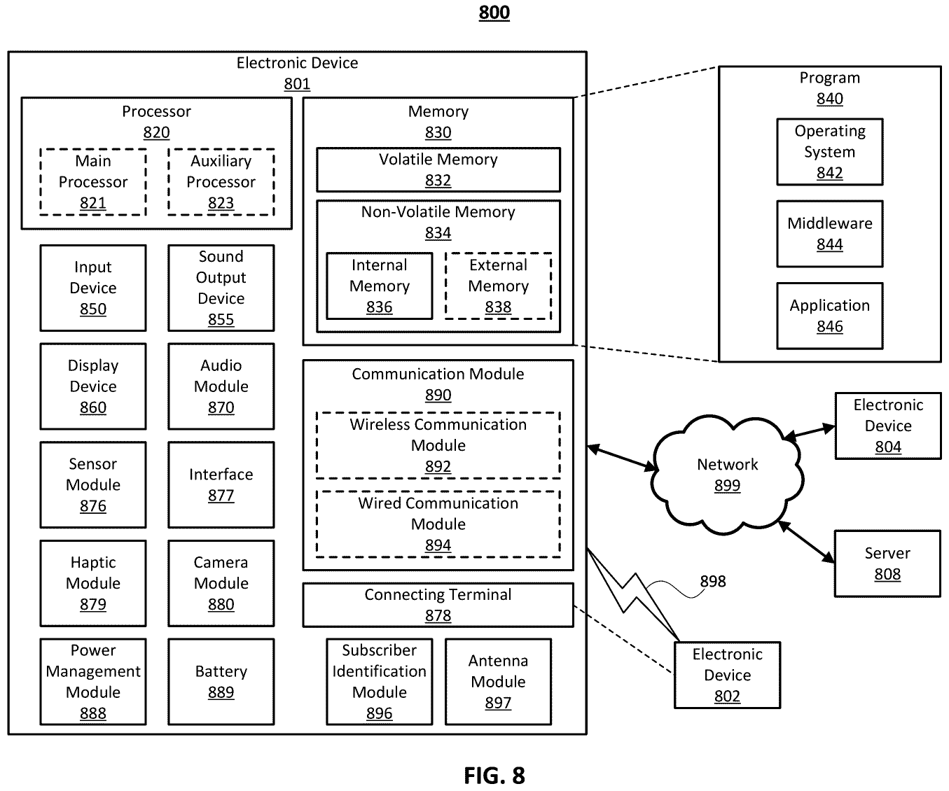

FIG. 8 is a block diagram of an electronic device in a network environment, according to an embodiment; and

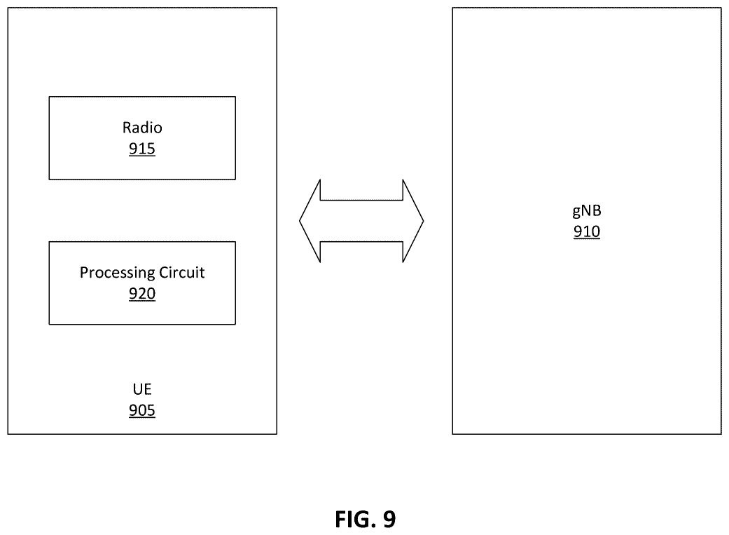

FIG. 9 shows a system including a UE and a gNB, in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In the 3GPP new radio (NR) framework, when a UE connects to a mobile network, the radio access network (RAN) is responsible for selecting the appropriate core network for the UE. This decision is based on several attributes of the UE, including its identifiers, the public land mobile network (PLMN) it has selected, and its location information, which encompasses the serving cell as known to the serving RAN node. NTN often features large cells that span vast regions, sometimes covering multiple countries or geographic territories. This can present challenges in scenarios where different core networks from multiple countries are connected to the same NTN RAN in a multi-operator core network (MOCN) sharing scenario. Particularly near country borders, accurately determining the appropriate core network for a connecting UE can be problematic due to the broad and imprecise nature of serving cell information.

There is also the risk of malicious UEs fraudulently altering their selected PLMN to connect to a different core network. In such cases, the access and mobility management function (AMF) is expected to disconnect the UE and notify the RAN node through an appropriate next generation (NG) application protocol (NGAP) value. This enables the RAN to take appropriate measures against future connection attempts by the same UE. While UEs can transmit GNSS measurements to the RAN via the radio resource control (RRC) protocol, this method has drawbacks. Similar to how a malicious UE might falsify its PLMN, it could also tamper with its GNSS measurements. Furthermore, transmitting GNSS measurements over RRC before non-access stratum (NAS) security has been established could compromise privacy and security. As such, relying solely on GNSS measurements sent over RRC is not considered a viable solution. Location information should only be communicated after NAS security has been established, and even then, regional regulations and policies might require user consent to acquire UE location information.

It may be necessary for the network to trust at least some of the information provided by the UE to verify its location in a reliable manner. However, if the provided information, such as the selected PLMN, GNSS measurements, and RRC measurements, is false or inaccurate, this could make it challenging to verify UE locations.

Determining a UE's location may be necessary in a 5G NR system with NTN satellite access to support services such as routing traffic and supporting emergency calls, in accordance with the national or regional regulatory requirements applicable to the UE.

Network operators supporting NTN must accurately know a UE's location to select the appropriate core network for the UE, enabling support for services subject to national regulations or other operational constraints. For example, the NTN Rel-18 framework has identified services that require accurate location information: PWS, LI, EMS, and charging and tariff notifications.

Solely depending on GNSS-based location information reported by the UE may not be reliable due to the potential for intentional or unintentional errors in the reported location data. Consequently, 3GPP has defined network-based functionality for verifying reported UE locations using the identifier of the serving cell (e.g., cell identification (ID)) for terrestrial networks. However, the much larger cell sizes in NTN, which may span borders between countries, means that cell ID information alone may not suffice to determine reliable location information, such as the UE's country of location.

Combining UE-reported GNSS information with network-based verification may enhance the reliability of core network selection in NTNs. While UEs can report GNSS data to the network, the network could independently verify this information using additional data. The logical location of the UE in NTN environments should clearly correlate with its physical geographical area, requiring a granularity that provides network location accuracy comparable to terrestrial networks. In terrestrial networks, verification relies on cell ID, aiming for a particular granularity related to cell size. A similar level of granularity should be considered for NTN environments to ensure accurate and reliable location verification.

As discussed above, 3GPP Rel-18 for NTN introduces guidelines for verifying the location of a UE for services such as PWS, LI, EMS, and charging and tariff notifications. This information underscores the necessity for precise and reliable location determination mechanisms, given the potential for inaccuracies and tampering in location reporting. Although 3GPP Rel-18 states that UEs be equipped with GNSS devices for location estimation, the effectiveness of GNSS can be significantly compromised. In certain regions, GNSS signals may be too weak or fall below the required noise margin, rendering the derived location data unreliable. Moreover, there's a risk of malicious tampering with UE location information, either by the users themselves or third parties, further exacerbating the challenge of dependable location verification.

Addressing these concerns, a multi-RTT solution may be used to determine a network-verified UE location within NTN environments. This method may include the exchange of PRS from the gNB to the UE and SRS from the UE back to the gNB. This method may also include measuring and reporting of the Rx-Tx time differences by both the gNB and the UE to an LMF, which then calculates the RTT. These operations may be repeated multiple times, enabling the LMF to accurately estimate the UE's location based on the aggregated data.

In the context of mobile telecommunications, particularly within 3GPP standards for 5G networks, the LMF is a functional entity responsible for managing the location of the UE and services provided to the UE. The LMF may be used to determine the position of the UE based on various inputs and measurements, such as those from the RAN and other location measurement units. The LMF processes this information to estimate and report the UE's location, supporting various applications and services that require precise location information, including emergency services, location-based services, and network management tasks.

The LMF may reside in the core network of the 5G system, interfacing with other core network functions such as the AMF and the unified data management (UDM) function. The LMF may be hosted in a storage device on a network node, such as a gNB, UE, satellite, server, or another electronic device. The LMF may also interface with the RAN to obtain the necessary measurements and information from the network nodes required to perform its location calculations.

However, the dynamic nature of NTNs, particularly in LEO scenarios where satellites exhibit high-speed movement, introduces additional complexities. The movement affects the DL subframe timing as observed by the UE and the UL subframe timing as observed by the gNB. This variability necessitates adaptations to the multi-RTT method to cater to the unique temporal dynamics of NTN environments.

Therefore, according to various embodiments disclosed herein, enhanced methodologies for defining UE Rx-Tx and gNB Rx-Tx time differences in the context of the multi-RTT method for a single satellite network-verified UE location in NTN applications are provided. These enhancements are useful for ensuring that the LMF may perform measurements using only one satellite to verify the location of a UE. Thus, the NTN location verification process may remain robust, accurate, and tamper-resistant, fulfilling the operational requirements set forth by 3GPP Rel-18 for NTN operations.

FIG. 1 is a diagram illustrating an NTN network environment, according to an embodiment.

Referring to FIG. 1, a network 100 may be a multiple access wireless communication system that supports a broadcast service, such as an NTN. The network 100 may be designed to support one or more standards, such as 3GPP. The network 100 may comprise the UE 101, satellite 102, and gNB 103.

The UE 101 may be able to transmit, receive, store, and process data. The UE 101 may be an electronic device including a transceiver system such as a mobile device, laptop, or other equipment.

The satellite 102 may be an orbiting platform capable of sending and receiving data from the UE 101 and the gNB 103. The satellite 102 may be in communication with the UE 101, where the satellite 102 may be able to transmit and receive data from the UE 101 over a communication link 104. The communication link 104 may include UL and DL data transmissions.

The gNB 103 may include an antenna capable of sending and receiving data from the satellite 102. The gNB 103 may be connected to or associated with a base station or logical radio node. The gNB 103 may be in communication with the satellite 102 over a communication link 105. The communication link 105 may include UL and DL data transmissions.

The cell 106 may be a geographic area where the UE 101 and other UEs are capable of communicating with the satellite 102. The size of the cell 106 may vary depending on the location of the satellite 102 relative to Earth. For example, geostationary equatorial orbit (GEO) satellites may allow for a larger cell 106 area, which may be between 200 kilometers (km) to 3,500 km in diameter, in one embodiment. Medium earth orbit (MEO) and LEO may have smaller associated cell 106 sizes. Furthermore, the distance from the satellite 102 to Earth may affect the transmission time of transmitting and receiving data between the UE 101 and the satellite 102, and between the satellite 102 and the gateway 103.

FIG. 2 illustrates a network signaling operation for performing an RTT measurement, according to an embodiment.

Referring to FIG. 2, a gNB and a UE are shown. The gNB and UE may correspond to gNB 103 and UE 101, respectively.

A multi-RTT method for NTN may be based on transmitting PRS from the gNB to the UE, and transmitting SRS from the UE to the gNB. Based on these operations, the gNB and the UE make measurements and report the measurements to the LMF. The LMF may calculate RTT according to Equation 1, below:

$$RTT = ( t 2 - t 1 ) + ( t 3 - t 4 ) \qquad Equation 1$$

To calculate (t2−t1) using the LMF, the gNB reports the gNB Rx-Tx time difference to the LMF, marked as 201 in FIG. 2. Similarly, to calculate (t3−t4) by the LMF, the UE reports the UE Rx-Tx time difference to the LMF, marked as 202 in FIG. 2.

In the case of NTN environments operating using LEO satellites, the dynamic nature of LEO satellite movement introduces significant challenges for communication protocols, particularly in terms of timing and signal processing. For example, in an LEO-600 scenario, where the satellite orbits approximately 600 km above Earth's surface, the satellite may move at a relatively fast speed of 7.56 km per second. This rapid movement has a pronounced effect on the DL subframes received by the UE from the gNB, leading to variations in the perceived duration of these subframes due to the Doppler effect.

FIG. 3 is a chart depicting DL subframe variation over time, according to an embodiment.

Referring to FIG. 3, an amount of DL subframe shrinkage or expansion is shown from the perspective of the UE, as a satellite gets closer to or further from the UE in a transparent payload.

FIG. 3 assumes the UE is located within the LEO-600 satellite's orbital plane. Accordingly, the satellite remains in view of the UE for about 13 minutes during its orbit for the LEO-600 satellite orbital plane. During this period, the relative velocity between the satellite and the UE causes the DL subframe durations to vary. Specifically, as the satellite approaches the UE, the DL subframes, as observed by the UE, appear to contract, being shorter than the standard 1 millisecond (ms) duration by up to 48 nanoseconds (ns). This effect is most pronounced when the satellite is directly overhead, at which point the DL subframe duration approaches the nominal value of nearly 1 ms. Conversely, as the satellite moves away from the UE, the observed DL subframe durations expand, exceeding the standard duration by approximately 48 ns.

This variation in DL subframe duration poses a unique challenge for accurately determining the timing and hence the location of the UE. Methods for timing and location estimation, designed for relatively static terrestrial network environments, may not be directly applicable in the highly dynamic NTN context (since the DL subframe variations are more pronounced in the LEO NTN environment). Therefore, solutions are proposed to address these challenges by providing modified measurement and reporting techniques that account for the temporal variations induced by satellite movement, thereby enhancing the performance and reliability of NTN operations.

FIG. 4 illustrates the DL subframe length as observed by the UE when a satellite in an LEO-600 NTN scenario passes overhead, according to an embodiment.

Referring to FIG. 4, this depiction helps to visualize the Doppler effect on signal timing where the length of DL subframes contracts as the satellite approaches the UE and expands as it recedes. Specifically, when a satellite is getting closer to the UE, then the DL subframe may be approximately 1 ms-48 ns. This corresponds to the interval of 0 minutes to ˜3.5 minutes in FIG. 3. On the other hand, when the satellite is getting farther from the UE, then the DL subframe may be approximately 1 ms+48 ns. This corresponds to the interval of ˜9.5 minutes to 13 minutes in FIG. 3. Furthermore, when the satellite is above the UE, then the Doppler effect is least pronounced, and the DL subframe may be ˜1 ms. This corresponds to ˜6.5 minutes in FIG. 3.

The measurement of the UE's Rx-Tx time difference is a process that typically spans tens of subframes. Due to the speed of the satellite, the cumulative measurement error in the DL subframe length after, for example, 20 subframes could approach nearly 1 us. If a method for measuring the UE Rx-Tx time difference relies solely on counting the number of DL subframes and presumes a constant subframe length, it may result in significant inaccuracies in the UE's location determined by the multi-RTT method.

Considering this, the total absolute value of the UE Rx-Tx time difference should be reported to the network, specifically to the LMF, to ensure measurement precision. The 3GPP TS 38.133 for Rel-18, in Section 10.1.25.3.1, outlines the procedure for absolute UE Rx-Tx time difference report mapping based on terrestrial networks, where it is reasonable to assume a fixed DL subframe duration due to stationary gNBs. In this terrestrial context, the reporting range for absolute UE Rx-Tx time difference measurement spans from −985024*T_{c} to 985024*T_{c}, with a resolution step of 2^{k}*T_{c} (where T_{c} is the transmission time interval, and k varies between 0 and 5, determined by whether measurements are taken in frequency range 1 (FR1) or frequency range 2 (FR2)). This implies that the reported UE Rx-Tx time difference value lies between approximately-0.5 ms and +0.5 ms with varying resolution steps. The calculation of the additional component of the UE Rx-Tx time difference is delegated to the LMF, which knows the indices of the subframes where the PRS and SRS are received and transmitted by the UE, allowing for a total UE Rx-Tx time difference to be computed under the assumption of constant subframe duration in terrestrial networks.

In NTN scenarios, on the other hand, such assumptions are not valid due to the variability in subframe duration caused by the satellite's relatively high velocity. Thus, the UE must report the total absolute value of the UE Rx-Tx time difference. To accommodate this, an extension of the reporting range for the absolute UE Rx-Tx time difference measurement should be used, covering only positive values. If the range were expanded to cover from 0 to 2²⁹*T_{c}, the reporting capability could support up to 273 ms for the absolute UE Rx-Tx time difference measurement. This extension would sufficiently account for the distance variations between receiving PRS and transmitting SRS without the need to adjust the existing resolution step of 2^{k}*T_{c}.

The above analysis of the LEO-600 scenario demonstrates that, due to the satellite's high speed, the length of the DL subframe as perceived by the UE can vary by as much as +/−48 ns. When considering UL subframes, the situation can become more complex.

FIG. 5 is a chart depicting UL subframe variation over time, according to an embodiment.

Referring to FIG. 5, since the UE compensates for timing based on the DL signal it receives, the UL subframe timing, as observed by the gNB, may undergo changes up to twice that observed in the DL subframe, which means variations could be up to 96 ns. This phenomenon is depicted by the chart illustrated in FIG. 5, which shows the amount of UL subframe shrinkage or expansion as the satellite's position relative to the UE changes in a transparent payload scenario.

However, there are factors to consider regarding the UE Rx-Tx time difference in this context. First, the UE may autonomously adjust its TA and subframe timing, informed by its GNSS position and the satellite's ephemeris. This autonomy may be used to maintain the UE's synchronicity with the satellite's timing. Second, TA commands (TAC) may be issued by the gNB when it detects that the UE's timing is drifting and falling out of sync, for example, as shown in FIG. 6A.

FIG. 6A illustrates a network signaling operation for performing timing adjustments, according to an embodiment.

Referring to FIG. 6A, a UE may perform autonomous timing adjustments 601 or may receive a TAC 602 from the gNB. TACs are a reaction to observed discrepancies and are designed to realign the UE's transmission timing with the network's expected timing.

These mechanisms may ensure that the UE remains in the “connected mode”, maintaining communication with the network. Consequently, it is reasonable to infer that if the gNB successfully receives and decodes the SRS, the UE has effectively managed its UL timing to match the network's expectations.

With this assumption, the gNB can measure the gNB Rx-Tx time difference in the same manner as outlined in the approach defined in 3GPP TS 38.215 for Rel-17. This approach is predicated on the reception of UL subframes with an average length of 1 ms.

Furthermore, aside from the reported gNB Rx-Tx time difference, the LMF can utilize the timestamps of the PRS and SRS to calculate the time difference between the transmission of PRS and the reception of SRS.

In practice, the specifics of when and how the UE executes autonomous TA adjustments, as well as the criteria for the gNB issuing TAC to the UE, may depend on the implementations of the UE and gNB, respectively. Nevertheless, the timing of received UL subframes may not be perfectly aligned. The gNB might still receive and decode UL subframes that are within a margin of half the cyclic prefix (±CP/2) misaligned from the expected 1 ms subframe boundaries of the gNB's DL signal. This misalignment may be accounted for as a measurement error in the gNB Rx-Tx time difference.

If such a margin of error persists, achieving the 3GPP accuracy requirement (e.g., 10 km for a network-verified UE location in NTN) may become challenging. However, if the UE reports the total value of its autonomous timing adjustments and those triggered by received TAC to the LMF, a more accurate calculation of the time difference between the transmission of PRS and the reception of SRS can be made.

By synthesizing one or more of the pieces of information discussed, including the reported gNB Rx-Tx time difference, autonomous and commanded timing adjustments, and the timestamps of PRS and SRS, the LMF can be equipped to calculate an accurate time difference between the transmission of PRS and the reception of SRS, thereby fulfilling the accuracy requirements for an NTN network-verified UE location.

FIG. 6B illustrates a network signaling operation for performing timing adjustments, according to an embodiment.

Referring to FIG. 6B, frames of gNB DL timing sequence, frames of a UE DL timing sequence, and frames of a UE UL timing sequence are shown. At subframe (SF) #i DL, the UE receives PRS after a DL propagation delay. However, the indices of the gNB DL SF and the UE DL SF are kept the same (SF #i in both cases). Even though the PRS may have been received some time after (e.g., a few milliseconds) the gNB transmitted it, from the UE's point of view, the PRS is received in the same SF at which the gNB transmitted the PRS (SF #i PRS).

From the UE UL point of view, the UE transmits SF #i earlier, such that the propagation delay in UL matches or is substantially similar to the propagation delay in DL. Therefore, a transmission by the UE in UL will arrive at the gNB with the same or substantially similar propagation delay as a transmission by the gNB in DL to the UE.

Accordingly, even though SF #i in UE UL, SF #i in gNB DL, and SF #i in UE DL may occur at relatively different times, virtually, each SF having index #i occurs at the same time. Furthermore, UE DL SF #i may be very close to UE UL SF #j, and the timing difference may be represented by UE Rx-Tx, which is the difference between SF #i when the UE receives PRS and the closest SF in the UE. Thus, the UE may report an SRS in UL to the LMF at SF #k, which may be based on a UE time difference (e.g., UE Rx-Tx).

FIG. 7 is a flowchart illustrating a method for verifying a UE location with the LMF in an NTN environment, according to an embodiment.

The method illustrated in FIG. 7 may be performed by an electronic device implementing the LMF, which may be a network node, terminal, UE, satellite, base station, or any other device connected to the network.

Referring to FIG. 7, in step 701, a PRS is received. The PRS may be received in DL from a base station. PRS and SRS time stamps may be received via the LMF. The time stamps may be reported by the UE and received by the LMF. The time stamps may include a PRS time stamp received by the UE (e.g., a PRS at DL), a time stamp of a closest subframe to the PRS in uplink (UL), and an SRS time stamp transmitted by the UE.

In step 702, a timestamp or subframe indices of the PRS in DL are determined, and a timestamp or subframe indices of the UE UL PRS's closest subframe are determined. A time difference between the PRS and the SRS may be determined via the LMF. The time difference may be determined based on the received time stamps. The time difference may be a UE Rx-Tx time difference or a gNB Rx-Tx time difference. The time difference may be used to determine TA adjustments.

In step 703, the UE time difference may be determined from the reception of the PRS to a transmission of an SRS based on the timestamps or subframe indices. The UE location may be determined based on the time difference via the LMF. The UE location may be determined using, for example, a multi-RTT method using the UE Rx-Tx and/or the gNB Rx-Tx determined based on the received time stamps.

In step 704, the SRS is reported to the LMF based on the UE time difference. As noted above, the LMF may be structurally implemented by a network node, terminal, UE, satellite, base station, or any other device connected to the network.

FIG. 8 is a block diagram of an electronic device in a network environment, according to an embodiment. The electronic device 801 of FIG. 8 may correspond to one or more of the UE 101, satellite 102, and/or gNB 103 shown in FIG. 1. One or more of the components shown in the electronic device 801 may be included in one or more of the UE 101, satellite 102, and/or gNB 103.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

FIG. 9 shows a system including a UE and a 910, in communication with each other, according to an embodiment.

Referring to FIG. 9, the UE 905 may include a radio 915 and a processing circuit (or a means for processing) 920, which may perform various methods disclosed herein, e.g., the method illustrated in FIG. 7. For example, the processing circuit 920 may receive, via the radio 915, transmissions from the gNB 910, and the processing circuit 920 may transmit, via the radio 915, signals to the gNB 910.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of reporting a user equipment (UE) time difference in a non-terrestrial network (NTN), the method comprising:
receiving, from a base station, a positioning reference signal (PRS) in downlink (DL);
determining a timestamp or subframe indices of the PRS in DL and a timestamp or subframe indices of the UE uplink (UL) PRS's closest subframe;
determining, based on the timestamps or subframe indices, the UE time difference from the reception of the PRS to a transmission of a sounding reference signal (SRS); and
reporting, to a location management function (LMF), the SRS based on the UE time difference.

2. The method of claim 1, further comprising:
verifying a UE location based on the UE time difference.

3. The method of claim 2, wherein the UE location is verified for one or more services including a public warning system (PWS), lawful interception (LI), an emergency service (EMS), or charging and tariff notifications.

4. The method of claim 1, further comprising:
transmitting an aggregate value of timing advance (TA) adjustments applied by the UE from a time point before the reception of the PRS to a time point at the transmission of the SRS.

5. The method of claim 4, wherein the aggregate value of TA adjustments includes autonomous adjustments or network-triggered adjustments.

6. The method of claim 1, further comprising:
transmitting an aggregate value of timing advance (TA) adjustments applied by the UE from a time point at the reception of the PRS to a time point at the transmission of the SRS.

7. The method of claim 6, further comprising reporting, by a base station to the LMF, a base station reception-transmission (Rx-Tx) time difference.

8. A method of reporting a base station time difference in a non-terrestrial network (NTN), the method comprising:
transmitting, to a user equipment (UE), a positioning reference signal (PRS) in downlink (DL);
receiving a timestamp or subframe indices of the PRS in DL and a timestamp or subframe indices of the UE uplink (UL) PRS's closest subframe;
determining, based on the timestamps or subframe indices, the base station time difference from the transmission of the PRS and a reception of a sounding reference signal (SRS); and
reporting, to a location management function (LMF), the SRS based on the base station time difference.

9. The method of claim 8, further comprising:
verifying a UE location based on the base station time difference.

10. The method of claim 9, wherein the UE location is verified for one or more services including a public warning system (PWS), lawful interception (LI), an emergency service (EMS), or charging and tariff notifications.

11. The method of claim 8, further comprising:
receiving an aggregate value of timing advance (TA) adjustments applied by the UE from a time point before the reception of the PRS to a time point at the transmission of the SRS.

12. The method of claim 11, wherein the aggregate value of TA adjustments includes autonomous adjustments or network-triggered adjustments.

13. The method of claim 8, further comprising:
receiving an aggregate value of timing advance (TA) adjustments applied by the UE from a time point at the reception of the PRS to a time point at the transmission of the SRS.

14. The method of claim 13, further comprising, reporting, by the base station to the LMF, a base station reception-transmission (Rx-Tx) time difference.

15. A non-transitory computer readable storage medium having instructions stored thereon, the instructions, when executed by a processor, cause the processor to:
receive, from a base station, a positioning reference signal (PRS) in downlink (DL);
determine a timestamp or subframe indices of the PRS in DL and a timestamp or subframe indices of the UE uplink (UL) PRS's closest subframe;
determine, based on the timestamps or subframe indices, a user equipment (UE) time difference from the reception of the PRS to a transmission of a sounding reference signal (SRS); and
reporting, to a location management function (LMF), the SRS based on the UE time difference.

16. The non-transitory computer readable storage medium of claim 15, wherein the instructions, when executed by the processor, further cause the processor to:
verify a UE location based on the UE time difference,
wherein the UE location is verified for one or more services including a public warning system (PWS), lawful interception (LI), an emergency service (EMS), or charging and tariff notifications.

17. The non-transitory computer readable storage medium of claim 15, wherein the instructions, when executed by the processor, further cause the processor to:
transmit an aggregate value of timing advance (TA) adjustments applied by the UE from a time point before the reception of the PRS to a time point at the transmission of the SRS.

18. The non-transitory computer readable storage medium of claim 17, wherein the aggregate value of TA adjustments includes autonomous adjustments or network-triggered adjustments.

19. The non-transitory computer readable storage medium of claim 15, wherein the instructions, when executed by the processor, further cause the processor to:
transmit an aggregate value of timing advance (TA) adjustments applied by the UE from a time point at the reception of the PRS to a time point at the transmission of the SRS.

20. The non-transitory computer readable storage medium of claim 19, wherein the instructions, when executed by the processor, further cause the processor to report, from a base station to the LMF, a base station reception-transmission (Rx-Tx) time difference.
